(19) United States
(12) Patent Application Publication
(10) Pub. No.: US 2014/0056109 A1
(43) Pub. Date: Feb. 27, 2014

(54) Seismic Source Array

(71) Applicant: John Philemon Norton, III, Houston, TX (US)

(72) Inventor: John Philemon Norton, III, Houston, TX (US)

(73) Assignee: BOLT TECHNOLOGY CORPORATION, Norwalk, CT (US)

(21) Appl. No.: 13/594,606

(22) Filed: Aug. 24, 2012

(51) Int. Cl. G01V 1/38; G01V 1/137

(52) U.S. Cl. 367/144

(57) ABSTRACT

A marine seismic source array includes multiple strings of marine seismic source elements. A first string has a first specified arrangement of air guns between a beginning of the first string and an end of the first string. A second string has a second, different specified arrangement of the air guns between a beginning of the second string and an end of the second string. The second arrangement is the reverse of the first arrangement. A specified arrangement of air guns may be defined, for example, by a number of air guns in each seismic source element, a chamber volume of each air gun, a spacing of the air guns, or any suitable combination of these and other parameters.

### BACKGROUND

Seismic source arrays are used as a source of seismic energy for marine seismic surveys. The array is typically towed by a vessel and can include several clusters of air guns, each submersed in water and suspended from a flotation device towed by the vessel. The vessel controls the array to generate seismic source signals. To generate a seismic source signal the vessel fires the air guns in the array, and the resulting seismic signal interacts with geological features beneath the ocean floor. Reflected seismic signals are collected and analyzed to identify properties of subsurface geological formations.

### SUMMARY

In a general aspect, a marine seismic source array includes two or more strings of seismic source elements. Each seismic source element may include one or more air guns.

In some aspects, the marine seismic source array includes a first string of seismic source elements and a second string of seismic source elements. The first string has a first specified arrangement of air guns between a beginning of the first string and an end of the first string. The second string has a second, different specified arrangement of the air guns between a beginning of the second string and an end of the second string. The second arrangement is the reverse of the first arrangement.

Implementations may include one or more of the following features. The first specified arrangement of air guns can be an arrangement of air gun chamber volumes. The first specified arrangement of air guns can be an arrangement of a number of air guns in each seismic source element. The first specified arrangement can be defined by a number of air guns in each seismic source element of the first string and a chamber volume of each air gun in each seismic source element of the first string.

Additionally or alternatively, implementations may include one or more of the following features. A first seismic source element at the beginning of the first string includes a single air gun having a first air gun chamber volume. A second seismic source element at the end of the first string includes two air guns each having a second, different air gun chamber volume. The marine seismic source array further includes a third and a forth seismic source element. The third seismic source element is at the end of the second string and includes a single air gun having the first air gun chamber volume. The fourth seismic source element is at the beginning of the second string and includes two air guns each having the second air gun chamber volume.

Additionally or alternatively, implementations may include one or more of the following features. Two or more, or all air guns in the first specified arrangement have equal air gun chamber volumes. Two or more air guns in the first specified arrangement have air gun chamber volumes that are different from one another. Two or more, or all, of the seismic source elements of the first string have an equal number of air guns.

Additionally or alternatively, implementations may include one or more of the following features. The first string includes a specified distance between each neighboring pair of seismic source elements of the first string. The second string includes the same specified distance between each neighboring pair of seismic source elements of the second string.

Additionally or alternatively, implementations may include one or more of the following features. The seismic source array includes a third string of seismic source elements and a fourth string of seismic source elements. The third string has the first specified arrangement of air gun chamber volumes between a beginning of the third string and an end of the third string. The fourth string has the second specified arrangement of air gun chamber volumes between a beginning of the fourth string and an end of the fourth string.

Additionally or alternatively, implementations may include one or more of the following features. The seismic source array can be included in a marine seismic system. The marine seismic system includes a control system communicably coupled to the seismic source elements.

In some implementations, these and other aspects may provide one or more of the following advantages. A seismic source array can use air guns having smaller chamber volumes to produce seismic signals that meet or exceed industry standards (e.g., 100 bar·meter far-field signal, or another signal strength). Omitting larger air guns may reduce wear and other costs in the system. In some instances, the marine seismic source array, or parts thereof, may be stored or packaged for transport more efficiently. For example, two or more of the strings may be paired, and the paired strings may have a width profile that allows the paired strings to be shipped together in a standard shipping container.

The details of one or more implementations are set forth in the accompanying drawings and the description below. Other features will be apparent from the description and drawings, and from the claims.

### DESCRIPTION OF DRAWINGS

FIG. 1 is a schematic diagram showing aspects of an example marine seismic source system.

FIGS. 2A and 2B are schematic diagrams showing aspects of an example marine seismic source array.

FIGS. 3A and 3B are schematic diagrams showing aspects of an example container system for a marine seismic source array.

FIGS. 4A and 4B are plots showing data from computer simulations of an example marine seismic source array.

Like reference symbols in the various drawings indicate like elements.

### DETAILED DESCRIPTION

A seismic source array includes strings of seismic source elements. Each seismic source element in a string can include one or more air guns having a particular specification, and the string can define an arrangement of air guns. The arrangement may be defined, for example, by the number of air guns in each seismic source element, the chamber volume or signal strength (or other specifications) of each air gun, the spacing of the air guns, the spacing of the seismic source elements, or any suitable combination of these and other parameters of the string. The arrangement may be defined between the beginning of the string to the end of the string. The beginning of the string is generally forward (i.e., toward the vessel) when the array is deployed behind a vessel, and the end of the string is generally to the rear (i.e., away from the vessel) when the array is deployed behind a vessel.

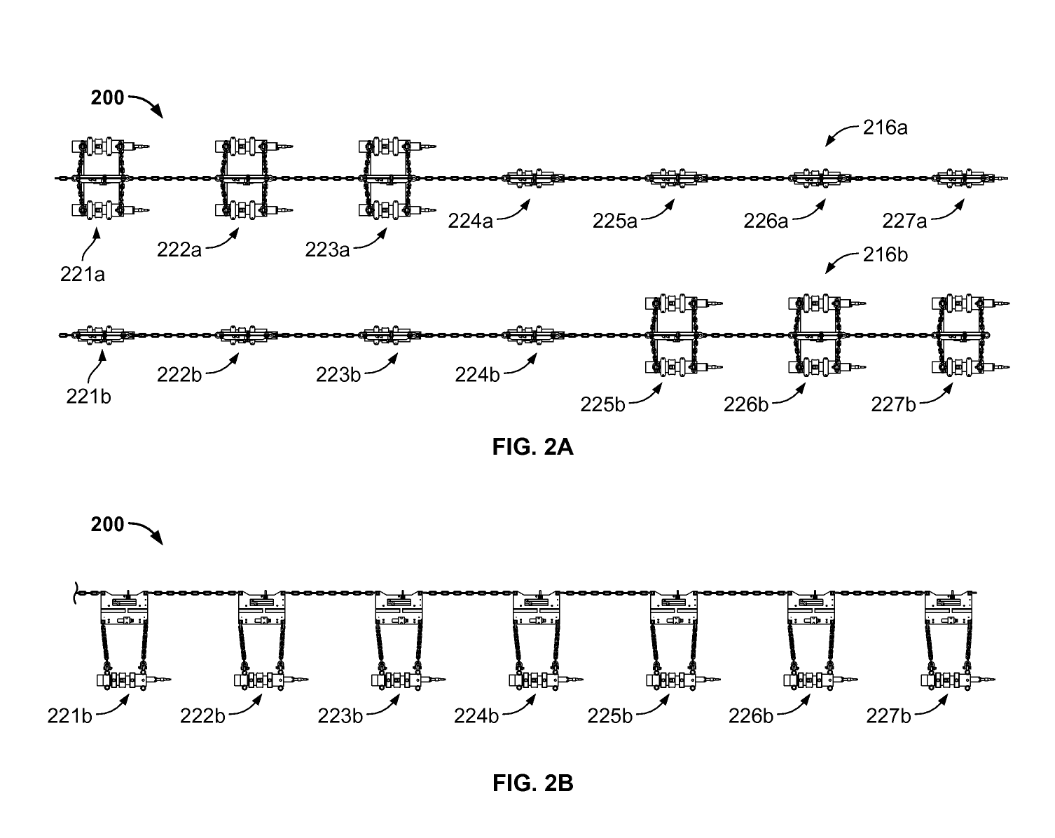

In some cases, the seismic source array includes two or more strings that have different arrangements. In some implementations, two strings have different arrangements that are symmetric, or one string's arrangement can be a mirror image of another string's arrangement. In some implementations, one string's arrangement is the reverse of another string's arrangement. In other words, the arrangement of air guns from the beginning to the end of one string can be the reverse of the arrangement of air guns from the beginning to the end of another string in the same array. An example is shown in FIGS. 2A and 2B for purposes of illustration; other arrangements (which may include additional or fewer air guns, additional or fewer seismic elements, different types of seismic source elements, different types of air guns or air gun clusters, or any other suitable features) may be used.

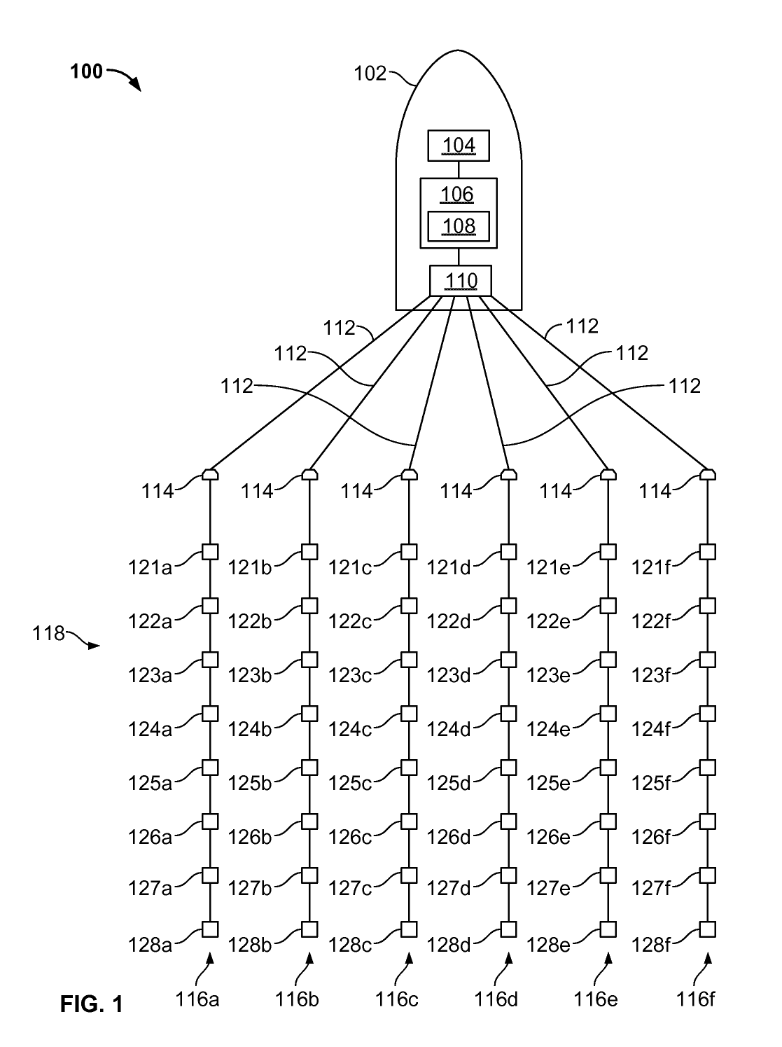

FIG. 1 is a schematic diagram showing aspects of an example marine seismic source system 100. The example marine seismic source system 100 includes a seismic source array 118 towed by a vessel 102. The seismic source array 118 includes multiple strings 116a, 116b, 116c, 116d, 116e, 116f. Although FIG. 1 illustrates an array that includes six strings, an array may include any suitable number of strings. For example, an array may include 2, 3, 4, 5, 6, 7, 8, or more strings.

Each string includes multiple seismic source elements. The seismic source elements of string 116a are numbered (beginning with the forward position) 121a, 122a, 123a, 124a, 125a, 126a, 127a, 128a; the seismic source elements of string 116b are numbered (again, beginning with the forward position) 121b, 122b, 123b, 124b, 125b, 126b, 127b, 128b; and so forth. Although FIG. 1 illustrates the strings each having eight seismic source elements, any suitable number of seismic source elements can be used. For example, a string may include 2, 3, 4, 5, 6, 7, 8, 9, 10, or more seismic source elements.

Each seismic source element in the seismic source array 118 may include one, two, three, or more marine air guns that generate an acoustic signal in the water. The seismic source elements in the seismic source array 118 may include different numbers of air guns. For example, some of the seismic source elements may each have a single air gun, while other seismic source elements may each include two or three air guns. In some cases, the seismic source elements in the seismic source array 118 may all include the same number of air guns.

The seismic source array 118 can include any suitable type of marine air guns. An air gun generally includes a pressure release assembly and an actuator. The pressure release assembly stores compressed air in one or more chambers, and the actuator actuates the pressure release assembly to release the compressed air and generate an acoustic signal. The chamber volume generally includes the volume of the chamber that store the compressed air. The chamber volume of an air gun may be defined by a single chamber, multiple chambers, or otherwise. The actuator can be, for example, a solenoid valve or another type of actuator. The actuator can operate based on electrical signals, magnetic signals, pneumatic signals, or any suitable combination of these and other types of signals.

In addition to air guns, the seismic source elements shown in FIG. 1 include additional components. For example, the seismic source elements can each include a flotation, a hangar plate, communication equipment, control and sensor equipment, air supply lines, and other features. Any suitable seismic source element may be used.

Each string in the seismic source array 118 can have a specified arrangement of air guns. The specified arrangement can include the number of air guns in each seismic source element, the spacing of the air guns, the air gun specifications (e.g., chamber volume, etc.), or other parameters. The air guns in a given string can have all the same specifications, or they may have different specifications. Example air gun specifications include chamber volume, loaded pressure, signal strength, and others. In this context, “same” is used broadly in the sense that two items (e.g., objects, quantities, etc.) may be considered the same if they are identical, similar, or substantially the same. For example, in some contexts, two air gun chamber volumes can be substantially the same if the difference between them is a small fraction (e.g., less than 2%) of the either air gun's respective chamber volume. As a particular example, in some implementations, a 99 cubic inch air gun has substantially the same chamber volume as a 100 cubic inch air gun.

In some examples, all air guns in a string have the same specifications (e.g., identical specifications, substantially the same specifications, etc.). For example, all air guns in a string may have the same chamber volume (e.g., identical chamber volumes, substantially the same chamber volumes, etc.). The string can define an arrangement of air guns, for example, by the number of air guns at each seismic source element, which may be represented {n₁, n₂, n₃, n₄, n₅, n₆, n₇, n₈} where nᵢ represents the number of air guns at the i^{th} seismic source element. Any suitable arrangement may be used. Examples include {2, 2, 2, 1, 1, 1, 1, 1}, {3, 3, 2, 2, 2, 1, 1, 1}, and {2, 1, 1, 1, 1, 1, 1, 1,}. Additionally or alternatively, the string may define an arrangement of air guns based on the distance between air guns, the depth of the air guns, the distance between seismic source elements, and other suitable parameters.

In some examples, all seismic source elements in a string have the same number of air guns (e.g., n₁=n₂=n₃=n₄=n₅=n₆=n₇=n₈}. For example, all seismic source elements in the string 116a may have one air gun, or all seismic source elements in the string 116a may have two air guns, etc. The string may define an arrangement of air guns, for example, by the air gun chamber volumes at each seismic source element. Any suitable arrangement may be used. For example, the first four seismic source elements may have a first chamber volume (e.g., 180 in³), and the last four seismic source elements may have a different chamber volume (e.g., 110 in³). As another example, the first three seismic source elements may include two air guns each having a first chamber volume (e.g., 110 in³), the next three seismic source elements may include two air guns each having a second, different chamber volume (e.g., 90 in³), and the last two seismic source elements may include two air guns each having a third, different chamber volume (e.g., 140 in³). Additionally or alternatively, the string may define an arrangement of air guns based on the distance between air guns, the depth of the air guns, the distance between seismic source elements, and other suitable parameters.

In some examples, some of the seismic source elements in a string have a different number of air guns than other seismic source elements in the same string, and some of the air guns in the string have different specifications than other air guns in the same string. In such cases, the string can define a specified arrangement of air guns by a combination of the number of air guns at each element and the volume of each air gun. The arrangement may be defined by additional or different parameters, such as, for example, the spacing of the air guns, the depth of the air guns, the spacing of the elements, or other parameters.

For at least one pair of strings in the seismic source array 118 shown in FIG. 1, the two strings in the pair are different, and one string is the reverse of the other string. In other words, the arrangement of air guns defined by one string is the reverse of the arrangement of air guns defined by the other string, and the two strings are not the same. For example, string 116a can have an arrangement that is the reverse of string 116b; string 116c can have an arrangement that is the reverse of string 116d; string 116a can have an arrangement that is the reverse of string 116f or string 116e; etc. Any pair of strings (including neighboring or non-neighboring pairs) can have reverse arrangements. In some cases, one or more of the strings is not included in such a pair. In other words, the seismic source array may include one or more strings that are not the reverse of any other string in the array. In some cases, each string in the seismic source array 118 is the reverse of at least one other string in the seismic source array 118.

As an example, in some implementations, strings 116a and 116b are different from each other and have reverse arrangements. In such cases, seismic source element 121a is the same (e.g., identical, substantially the same, etc.) as seismic source element 128b. Similarly, seismic source element 122a is the same as seismic source element 127b; seismic source element 123a is the same as seismic source element 126b; seismic source element 124a is the same as seismic source element 125b; seismic source element 125a is the same as seismic source element 124b; seismic source element 126a is the same as seismic source element 123b; seismic source element 127a is the same as seismic source element 122b; and seismic source element 128a is the same as seismic source element 121b. One element can be the same as another in the sense that one element has the same number of air guns and the same air gun specifications as the other.

In one specific example, the seismic source element 121a at the beginning of the string 116a has a single air gun having a chamber volume of c₁, and the seismic source element 128b at the end of the string 116b also has a single air gun having a chamber volume of c₁. The seismic source element 128a at the end of the string 116a has two air guns each having a chamber volume c₈, and the seismic source element 121b at the beginning of the string 116b has two air guns each having the same chamber volume c₈. The rest of the seismic source elements 122a to 127a are also the reverse of the seismic source elements 122b to 127b, resulting in a reversed configuration of the strings 116a and 116b.

In some implementations, two strings having a reverse arrangement can produce seismic signals that meet industry standards, and the strings may require less total chamber volume than some conventional systems that also meet the same standards. The reduced total chamber volume can translate into less chamber volume in each air gun unit. Lower air gun volume may lead to a lower rate of wear (some air guns having larger chamber volumes may have higher component wearing rates). In some implementations, two strings having a reverse arrangement can be containerized or shipped more efficiently. For example, the two strings may fit into a standard-sized shipping container.

In the example marine seismic source system 100, the vessel 102 includes a navigation center 104, a command center 106, and one or more reels 110. The vessel 102 may include an air supply (not shown) that provides pressurized air to the air guns in the seismic source array 118. In some cases, an operator pressurizes the air guns using the pressurized air from the air supply. An air supply may include a cylinder or chamber that store gas at high pressure, a pump that pressurize the gas, regulators that control gas pressure, valves that control gas flow, and/or other features. The pressurized air provided to the air guns is stored in one or more chambers in the pressure release assembly of the air gun and released by the pressure release assembly to generate the seismic signal. The pressurized air may also be stored in one or more chambers in an actuator of the air gun and released by the actuator to actuate the pressure release assembly.

The pressurized or compressed air used by a marine seismic system and/or by components of a marine seismic source system may include any type of compressible fluid. For example, the air supply on the vessel 102 may include supplies of helium, nitrogen, oxygen, carbon dioxide, argon, or any combination of these and/or other gases. For example, the compressed air communicated to the marine air guns and released by the marine air guns to generate the acoustic signal may include one or more of these example gases in any ratio or combination. Some marine air guns may also generate an acoustic signal by releasing non-compressible fluid. For example, in some instances a marine air gun releases water to generate an acoustic signal in water.

The vessel 102 may include a power supply that generates electrical power for operating one or more components of the marine seismic source system 100. A power supply may include a DC voltage supply that provides a constant voltage, an AC voltage supply that provides a time-varying voltage, and/or other types of power supply. The vessel 102 may include additional and/or different features.

In the example shown in FIG. 1, each of the strings 116a to 116f is coupled to an umbilical 112 extending from the reels 110. The umbilical 112 includes communication links supporting communications between the command center 106 and the air guns at each of the seismic source elements 121a to 128f. Each umbilical 112 includes a housing 114. The housing 114 may house communication electronics or other components associated with the respective string.

The navigation center 104 navigates the vessel 102. The navigation center 104 may navigate the vessel 102 based on automated and/or manual controls. For example, the navigation center 104 may be programmed to guide the vessel 102 through a trajectory specified for one or more seismic surveys. During a seismic survey, the navigation center 104 may navigate based on data stored locally on the vessel 102, based on global positioning system (GPS) data received by the vessel, based on data received wirelessly (e.g., via satellite, via radio frequency transmission, and/or other medium) from a remote location, and/or based on other types of information.

The navigation center 104 may communicate with the command center 106. For example, the navigation center 104 may send the command center 106 instructions to fire the seismic source array 118, and/or the command center 106 may send the navigation center 104 information relating to the status of the air gun of each seismic source element 121a to 128f of the seismic source array 118 (e.g., location information, firing status information, etc.), which may include information relating to individual seismic source elements, information relating to individual air guns in the seismic source array 118, and/or information relating to the seismic source array 118 as a whole.

The command center 106 operates the seismic source array 118 based on communications with the seismic source elements. The command center 106 includes a communication interface 108 that transmits data to and receives data from the elements in the seismic source array 118. The command center 106 may include additional and/or different features. The command center 106 may include a computer system, for example, that includes processors running software for performing some or all of the functionality of the command center. The computer system may include memory that can store data received from and/or relating to operations of the air guns. The computer system may include display devices (e.g., monitors, etc.) that can display the data in various formats and/or user interface devices (e.g., keyboard, mouse, etc.) that receive user input. Generally, the command center 106 may receive, store, analyze, generate, and/or transmit data relating to the seismic source array 118 and/or data relating to other aspects of a seismic survey. In some instances, some or all of the command center 106 computing operation and functionality may be performed at a remote location. The command center 106 may include a power supply that provides electrical power provided to the seismic source array 118. The power supply may supply electrical energy at one or more voltage levels (e.g., 5, 10, 20, 40, 80 Volts, etc.). The command center 106 may control the level of electrical voltage and/or power provided to each seismic source element.

The communication interface 108 transmits electrical power and commands and/or other information to the seismic source elements. The commands may be based on data received from the navigation center 104, data stored or generated locally by the command center 106, data received from a remote location (e.g., remote from the vessel 102), and/or other data. The commands sent to the seismic source elements may include various types of instructions for conducting a seismic survey. For example, the commands may include a fire command, instructions to prepare for a fire command, commands to reconfigure an air supply valve, requests for data, and/or other types of commands. The commands and/or other information sent from the communication interface 108 may be addressed to all air guns, to individual air guns, to individual seismic source elements, and/or to subsets of air guns. For example, the communication interface 108 may address a command to an individual air gun or an individual seismic source element by transmitting an identifier with the command (e.g., as a header), where the identifier corresponds to the individual air gun or seismic source element. Each air gun or seismic source element may have a unique identifier.

The communication interface 108 receives information from each seismic source element. The information received from a seismic source element may include various types of data relating to a seismic survey, status information of the seismic source element, or other information. The information may include data collected by transducers at the seismic source element, data generated by a digital controller at the seismic source element, or other data.

In an example aspect of operation, the vessel 102 tows the seismic source array 118 through water associated with a target formation. The command center 106 can initialize the seismic source array 118, for example, by initiating an air supply to pressurize the air guns of the seismic source array 118, by sending instructions to the seismic source elements, or by performing other operations. The command center 106 can fire the seismic source array 118, for example, by sending a fire command to the seismic source elements. Firing the seismic source array may produce a seismic signal, and a sensor array may detect the seismic signal reflected by the target formation. The detected signal may be processed to identify geological properties of the target formation. The seismic source array 118 can be fired at particular locations, at particular times, or any suitable combination. In some instances, the seismic source array is fired repeatedly as the seismic source array 118 is towed along a specified trajectory.

The particular layout and arrangement of air guns and other components in a seismic source system can depend on the context of the seismic survey, the target formation, the type of vessel used, or a combination of these and other considerations. As such, the example configurations described here are not exhaustive; rather, the examples described here can be adapted for particular implementations as appropriate for a given operating environment, vessel, target formation, or other variables.

FIGS. 2A and 2B are schematic diagrams showing aspects of an example marine seismic source array 200. FIG. 2A illustrates a top view of the example seismic source array 200; and FIG. 2B illustrates a side view. In some instances, the example seismic source array 200 may be applied to the seismic source system 100 illustrated in FIG. 1. First referring to FIG. 2A, the example seismic source array 200 includes two strings 216a and 216b. Each of the two strings 216a and 216b includes seven seismic source elements 221a to 227a, and 221b to 227b, respectively. The string 216a has the seismic source element 221a at the beginning of the string and the seismic source element 227a at the end of the string. The string 216b has the seismic source element 221b at the beginning of the string and the seismic source element 227b at the end of the string. The string 216a includes a specified distance between each neighboring pair of seismic source elements; and the string 216b includes the same specified distance between each neighboring pair of seismic source elements.

As illustrated in FIG. 2A, the seismic source elements 221a to 223a include two air guns each; and the seismic source elements 224a to 227a include a single air gun each. The number of air guns in the string 216a may be expressed {2, 2, 2, 1, 1, 1, 1}. The string 216b has the reverse arrangement: the number of air guns in the string 216b may be expressed {1, 1, 1, 1, 2, 2, 2}. Overall, the two strings 216a and 216b define a point-symmetry or point-reflection symmetry (e.g., symmetric about the point at half of the length of the string 216a and half the distance from the string 216a to the string 216b). In some cases, such an arrangement can generate substantially isometric seismic signals. In some cases, such an arrangement can use relatively small air gun chamber volumes to produce a signal amplitude that meets industry standards.

In some implementations, the strings 216a and 216b of the example seismic source array 200 can have the parameters shown in Table 1 or other parameters. The example seismic source array 200 includes 20 air guns in total (each string 216a and 216b has 10 air guns distributed into the 7 seismic source elements 221a to 227a, and 221b to 227b). The total chamber volume of the 20 air guns is 2740 cubic inches.

TABLE 1
Seismic source array configuration

| Array parameter | Array value |
|---|---|
| Number of guns | 20 |
| Total volume (cu.in). | 2740.0 (44.9 liters) |
| Peak to peak (bar-m.) | 100 +/− 2.02 (10 +/− 0.202 MPa, |
| | ~260 db re 1 muPa. at 1 m.) |
| Zero to peak (bar-m.) | 53.5 (5.35 MPa, 255 db re 1 muPa. |
| | at 1 m.) |
| RMS pressure (bar-m.) | 4.97 (0.497 MPa, 234 db re 1 muPa. |
| | at 1 m.) |
| Primary to bubble (peak to peak) | 34.3 +/− 5.32 |
| Bubble period to first peak (sec.) | 0.125 +/− 0.0275 |

The configuration of the example seismic source array 200 can be analyzed by computer simulations. In some example computer simulations, the strings 216a and 216b are placed in parallel and 10 meters apart from each other. The seismic source element 221a is lined up with the seismic source element 221b in the direction of travel (referring to FIG. 2B for the side view). Every two adjacent seismic source elements are placed about 1.86 meters apart. The seismic source elements 221a to 227b can have different chamber volumes as shown in Table 2.

TABLE 2
Seismic source element chamber volumes

| | Seismic Source Element | | | | | | |
|---|---|---|---|---|---|---|---|
| | 221a | 222a | 223a | 224a | 225a | 226a | 227a |
| Chamber Volume (in³) | 140 | 110 | 140 | 180 | 180 | 140 | 90 |
| | Seismic Source Element | | | | | | |
| | 221b | 222b | 223b | 224b | 225b | 226b | 227b |
| Chamber Volume (in³) | 90 | 140 | 180 | 180 | 140 | 110 | 140 |

In this example, for each seismic source element having two air guns, both air guns have the same volume. The chamber volumes shown in Table 2 are one example; any suitable combination of chamber volumes may be used.

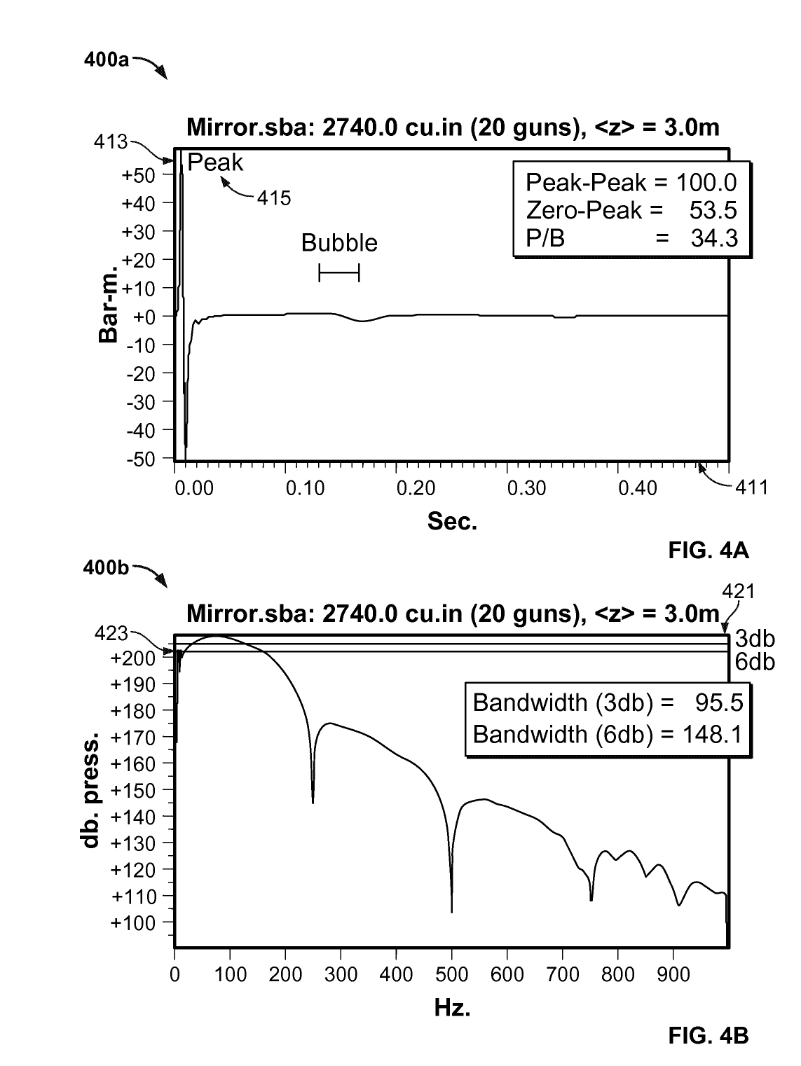

Hydrophones or other acoustic sensors may be placed far-field (e.g., substantially infinite vertical) to capture the acoustic signals generated by a seismic source array. The far-field signal may be simulated by computer software. In example computer simulations, the air guns of the seismic source array 200 are fired simultaneously to generate an acoustic signal. The acoustic signal can be characterized using a simulated signature graph (e.g., far-field dynamics) and a simulated amplitude spectrum (e.g., in units of dB, relative to 1 microPa per Hz. at 1 m.). Example data from the numerical simulations is presented and further discussed in FIGS. 4A and 4B.

Now referring to FIG. 2B, the side view of the strings 216a and 216b are illustrated (showing the seismic source elements 221b to 227b of the string 216b). The example seismic source array 200 can be deployed at the same (e.g., identical, substantially similar, etc.) depth. For example, the seismic source elements 221a to 227b of the strings 216a and 216b can be deployed approximately in the horizontal plane parallel to the water surface. Although in the example seismic source array 200 the seismic source elements 221a to 227b have one vertical level, two or more vertical levels may be used. For example, a vertical cluster of air guns may be used in each seismic source element 221a to 227b (e.g., in the side view of FIG. 2B, multiple vertical planes of air guns are presented in each seismic source element).

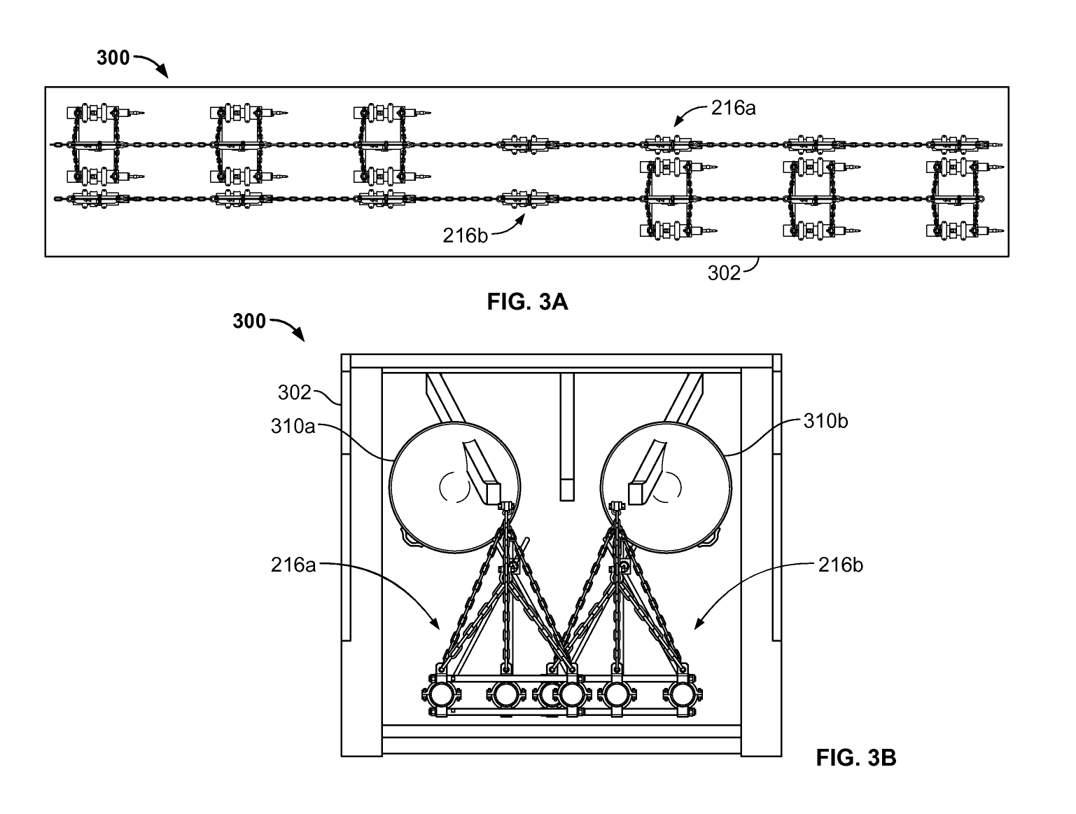

FIGS. 3A and 3B are schematic diagrams showing aspects of an example container system 300 for a marine seismic source array. The example container system 300 illustrates the strings 216a and 216b in a container 302. The container 302 can be any appropriate shipping container. For example, the container 302 can be an industry standard shipping container, such as a 40 ft container, a 20 ft container, or another similar container. In some cases, the container 302 can be a standard 40 ft container of 8 feet wide, 8.5 feet high, and 40 feet long. The container 302 can be used to store, transport, or deploy the strings 216a and 216b, and possibly other components of a seismic source array. Multiple containers may be used. In the example container system 300 illustrated in FIGS. 3A and 3B, the container 302 takes advantage of the point-symmetry of the strings 216a and 216b to achieve a smaller width profile with multiple air guns. For example, the seismic source element 221a having two air guns can fit with the seismic source element 221b having a single air gun into the width of the container 302

First referring to FIG. 3A, a top view of the container system 300 is shown. Because the strings 216a and 216b have arrangements that are reverse to each other, the total width profile can be smaller than the sum of each individual width profile. For example, both strings 216a and 216b individually occupy a width of two parallel air guns, but the total width required for storage is less than three parallel air guns, instead of a sum of four air guns.

As shown in FIG. 3B, the container 302 can further include flotations 310a and 310b and any other suitable components of a seismic source array. In some implementations, the container 302 can transport the strings 216a and 216b as part of the seismic source array. The container 302 may be configured to deploy the strings 216a and 216b in connection with a vessel of opportunity.

The container system 300 shows, by way of example, characteristics that may be present in a seismic source array. The seismic source arrays described here can be configured in the manner shown or in any other suitable manner. For example, although some seismic source arrays can be configured for storage or transport in standard sized shipping containers, some seismic source arrays are not configured for storage or transport in a container system. Moreover, some seismic source arrays may be stored or transported in a different type of container or in a different manner.

FIGS. 4A and 4B are plots showing data from computer simulations of the example seismic source array 200 shown in FIG. 2A. FIG. 4A shows a plot 400a of the signature of the seismic signal generated by the example seismic source array 200. FIG. 4B shows a plot 400b of the filtered amplitude spectrum of the seismic signal generated by the example seismic source array 200. The plots 400a and 400b were produced using GUNDALF array modeling suite, revision AIR7.1c, available from Oakwood Computing Associates Ltd. The simulations used a sampling rate of 2000 Hz, and 1000 data samples (0.5 seconds) were taken. The simulated depth of the example seismic source array was 3 meters, and the simulated operating pressure was 2250 psi. The plots 400a and 400b are used here as examples to illustrate characteristics of the example seismic source array 200. Other seismic source arrays will produce data having different characteristics.

First turning to FIG. 4A, the plot 400a includes an x-axis 411 indicating time in seconds and a y-axis 413 indicating signal strength in ba·meters. The plot 400a shows the far-field signal strength for the first 0.5 seconds of the firing of the seismic source array 200. At time=0.00 seconds, the seismic source array 200 fires all air guns of the strings 216a and 216b. The plot shows a simulated signal, as would be measured by a hydrophone placed at infinite vertical far-field. The simulation includes assumptions that the source ghost has been included, with a direct input of value −1.0. The cable ghost has been switched off. The plot 400a shows simulated performance aspects of the seismic source array 200, and generally indicates that the seismic source array can, in some implementations, produce a signal that meets industry standards. For example, one standard is the generated peak-to-peak signal being greater than or equal to 100 bar·meters, as indicated by the peak 415 and the corresponding negative peak in the plot 400a. The plot 400a shows a peak-to-peak differences at over 100 bar·meters and zero to peak at 53.5 bar·meters. The plot 400a shows a primary to bubble ratio of 34.3. The bubble period to the first peak is about 0.125 s.

Turning now to FIG. 4B, the plot 400b shows the filtered amplitude spectrum characterizing the signals produced by the seismic source array 200 in the numerical simulation described above. The x-axis 421 represents signal frequency in Hz, the y-axis 423 represents signal amplitude in db. The signal has been filtered using standard band pass filter having a bandwidth of 0 to 256 Hz.

The simulated plots 400a and 400b are provided as examples of one example configuration of a seismic source array. The seismic source arrays described here can be configured to produce signals having different characteristics. For example, a seismic source array can be configured for a particular operating environment, for a particular target formations, or based on other factors.

A number of implementations have been described. Nevertheless, it will be understood that various modifications may be made. Accordingly, other implementations are within the scope of the following claims.

What is claimed is:

1. A marine seismic source array comprising:
a first string of seismic source elements having a first specified arrangement of a plurality of air gun chamber volumes between a beginning of the first string and an end of the first string; and
a second string of seismic source elements having a second, different specified arrangement of the plurality of air gun chamber volumes between a beginning of the second string and an end of the second string, the second arrangement being the reverse of the first arrangement.

2. The marine seismic source array of claim 1, wherein the first specified arrangement is defined by:
a number of air guns in each seismic source element of the first string; and
a chamber volume of each air gun in each seismic source element of the first string.

3. The marine seismic source array of claim 1, wherein:
a first seismic source element at the beginning of the first string includes a single air gun having a first air gun chamber volume;
a second seismic source element at the end of the first string includes two air guns each having a second, different air gun chamber volume;
a third seismic source element at the end of the second string includes a single air gun having the first air gun chamber volume; and
a fourth seismic source element at the beginning of the second string includes two air guns each having the second air gun chamber volume.

4. The marine seismic source array of claim 1, wherein two or more air guns in the first specified arrangement have equal air gun chamber volumes.

5. The marine seismic source array of claim 4, wherein all air guns in the first specified arrangement have equal air gun chamber volumes.

6. The marine seismic source array of claim 1, wherein two or more air guns in the first specified arrangement have air gun chamber volumes that are different from one another.

7. The marine seismic source array of claim 1, wherein two or more of the seismic source elements of the first string have an equal number of air guns.

8. The marine seismic source array of claim 7, wherein all of the seismic source elements of the first string have an equal number of air guns.

9. The marine seismic source array of claim 1, wherein the first string includes a specified distance between each neighboring pair of seismic source elements of the first string, and the second string includes the same specified distance between each neighboring pair of seismic source elements of the second string.

10. The marine seismic source array of claim 1, further comprising a third string of seismic source elements and a fourth string of seismic source elements.

11. The marine seismic source array of claim 10, wherein:
the third string has the first specified arrangement of the plurality of air gun chamber volumes between a beginning of the third string and an end of the third string; and
the fourth string has the second specified arrangement of the plurality of air gun chamber volumes between a beginning of the fourth string and an end of the fourth string.

12. A method of operating a marine seismic system, the method comprising:
pressurizing air guns of a seismic source array that includes:
a first string of seismic source elements having a first specified arrangement of a plurality of air gun chamber volumes between a beginning of the first string and an end of the first string; and
a second string of seismic source elements having a second, different specified arrangement of the plurality of air gun chamber volumes between a beginning of the second string and an end of the second string, the second arrangement being the reverse of the first arrangement; and
firing the air guns of the seismic source array.

13. The method of claim 12, wherein the first specified arrangement is defined by:
a number of air guns in each seismic source element of the first string; and
a chamber volume of each air gun in each seismic source element of the first string.

14. The method of claim 12, wherein firing the air gun produces a far-field pressure signal having a peak-to-peak amplitude of at least 100 bar meters.

15. A marine seismic source array comprising:
a first string of seismic source elements that each include at least one air gun, the first string having a first specified arrangement of the number of air guns in each seismic source element between a beginning of the first string and an end of the first string; and
a second string of seismic source elements that each include at least one air gun, the second string having a second, different specified arrangement of the number of air guns in each seismic source element between a beginning of the second string and an end of the second string, the second arrangement being the reverse of the first arrangement.

16. The marine seismic source array of claim 15, wherein a first subset of the seismic source elements in the first string are single-gun seismic source elements, and a second subset of the seismic source elements in the first string are two-gun seismic source elements.

17. The marine seismic source array of claim 15, wherein two or more air guns in the first specified arrangement have equal air gun chamber volumes.

18. The marine seismic source array of claim 17, wherein all air guns in the first specified arrangement have equal air gun chamber volumes.

19. The marine seismic source array of claim 15, wherein two or more air guns in the first specified arrangement have air gun chamber volumes that are different from one another.

20. The marine seismic source array of claim 15, wherein two or more of the seismic source elements of the first string have an equal number of air guns.
